(19) United States
(12) Patent Application Publication
(10) Pub. No.: US 2025/0079590 A1
(43) Pub. Date: Mar. 6, 2025

(54) BATTERY DEVICE AND BATTERY MANAGEMENT METHOD

(71) Applicant: C-TECH UNITED CORPORATION, New Taipei City (TW)

(72) Inventors: CHIH-KUN YANG, New Taipei City (TW); CHUN-HUNG CHOU, New Taipei City (TW); HSIN-DAI PAN, New Taipei City (TW); SHYAN-DAR TARNG, New Taipei City (TW)

(21) Appl. No.: 18/457,355

(22) Filed: Aug. 29, 2023

(51) Int. Cl. H01M 50/204; H01M 10/42; H01M 10/48

(52) U.S. Cl. CPC H01M 50/204; H01M 10/425; H01M 10/486; H01M 2010/4271; H01M 2220/20

(57) ABSTRACT

A battery device and a battery management method are provided. The battery device includes two battery packs and a management module that can obtain a piece of battery health data for each of the two battery packs. When the management module detects that a first variation between two pieces of the battery health data is greater than 2%, the management module selects one of the two battery packs in which the battery health data is high to supply power to an electric bicycle, and another one of the two battery packs in which the battery health data is low to suspend operation. When the management module detects that the first variation between the two pieces of the battery health data is less than 2%, the management module selects one of the battery packs to supply power to the electric bicycle according to a first rule.

### FIELD OF THE DISCLOSURE

The present disclosure relates to a battery device, and more particularly to a battery device and a battery management method for an electric bicycle.

### BACKGROUND OF THE DISCLOSURE

In order to ensure that electric bicycles have sufficient stored electric energy, the electric bicycles on the market are generally equipped with a battery device that includes two battery packs as a power supply. However, a power supply mode of a conventional battery device is mostly to switch to one of the two battery packs for discharge when another one of the two battery packs is discharged to a low voltage level. This may cause the number of times that each of the two battery packs reaches a peak temperature to be increased, thereby reducing the service life of each of the two battery packs.

### SUMMARY OF THE DISCLOSURE

In response to the above-referenced technical inadequacy, the present disclosure provides a battery device and a battery management method for an electric bicycle.

In order to solve the above-mentioned problem, one of the technical aspects adopted by the present disclosure is to provide a battery device. The battery device is configured to be installed on an electric bicycle, and includes two battery packs and a management module. The management module is electrically coupled to the two battery packs. The management module is configured to obtain a piece of battery health data for each of the two battery packs. When the management module detects that a first variation between two pieces of battery health data is greater than 2%, the management module selects one of the two battery packs in which the battery health data is high to supply power to the electric bicycle, and another one of the two battery packs in which the battery health data is low is controlled to suspend operation. When the management module detects that the first variation between the two pieces of the battery health data is less than 2%, the management module selects one of the two battery packs to supply power to the electric bicycle according to a first rule.

In order to solve the above-mentioned problem, another one of the technical aspects adopted by the present disclosure is to provide a battery management method. The battery management method is applied to a battery device of an electric bicycle having two battery packs. The battery management method includes: obtaining a piece of battery health data for each of the two battery packs; determining a first variation between two pieces of the battery health data is greater than 2%, wherein one of the two battery packs in which the battery health data is high to supply power to the electric bicycle and another one of the two battery packs in which the battery health data is low is controlled to suspend operation when the first variation is greater than 2%, and a piece of battery capacity data is obtained for each of the two battery packs when the first variation is less than 2%; determining whether a second variation between two pieces of the battery capacity data is greater than 50%, wherein one of the two battery packs in which the battery capacity data is high to supply power to the electric bicycle and another one of the two battery packs in which the battery health data is low is controlled to suspend operation when the second variation is greater than 50%, and a sampled voltage variation and a surface temperature of each of the two battery packs within a unit of time are obtained when the second variation is less than 50%; selecting one of the two battery packs in which the sampled voltage variation is high to supply power to the electric bicycle, and another one of the two battery packs in which the sampled voltage variation is low is controlled to suspend operation; and selecting one of the two battery packs whose surface temperature is greater than a predetermined threshold value to be controlled to suspend operation, and another one of the two battery packs whose surface temperature is less than or equal to the predetermined threshold value supplies power to the electric bicycle.

Therefore, in the battery device and the battery management method provided by the present disclosure, by virtue of “in response to the management module detecting that a first variation between the two pieces of the battery health data being greater than 2%, the management module selects one of the two battery packs in which the battery health data is high to supply power to the electric bicycle, and another one of the two battery packs in which the battery health data is low is controlled to suspend operation,” the battery device can reduce the number of times that the two battery packs reach a peak temperature, thereby improving the overall service life of the battery device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit block diagram of a battery device according to a first embodiment of the present disclosure;

FIG. 2 is a graph illustrating a relationship between an amp hour and a temperature of the battery device according to the first embodiment of the present disclosure; and

FIG. 3 is a flowchart of a battery management method according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

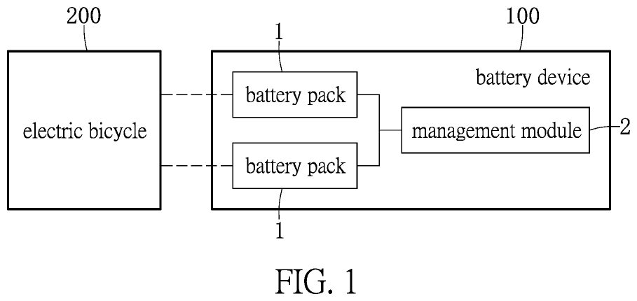

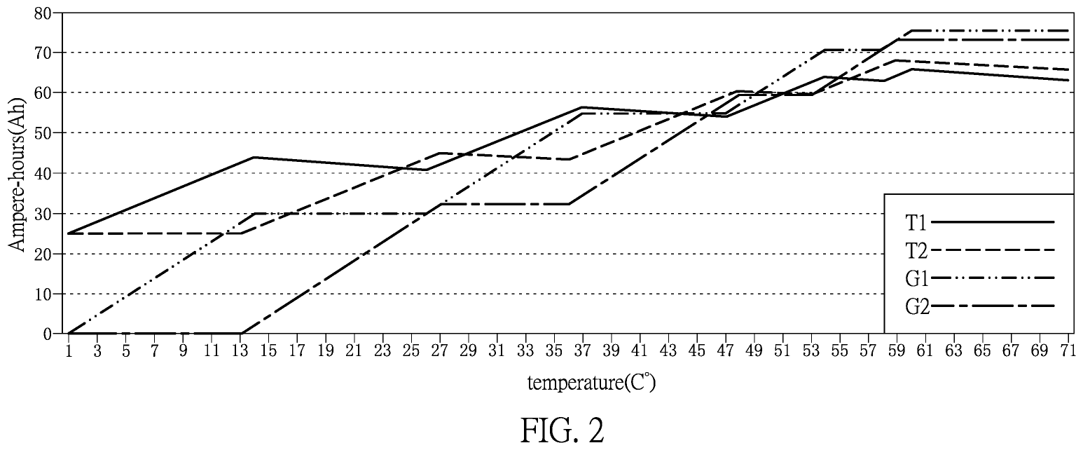

Referring to FIG. 1 and FIG. 2, a first embodiment of the present disclosure provides a battery device 100. As shown in FIG. 1, the battery device 100 can be installed on an electric bicycle 200, so as to be used as a power supply of the electric bicycle 200. The battery device 100 includes two battery packs 1 and a management module 2. The following description describes the structure and connection relation of each component of the battery device 100.

Referring to FIG. 1, each of the two battery packs 1 in the present embodiment has a plurality of batteries (not shown), and the management module 2 is electrically coupled to the two battery packs 1, so that the two battery packs 1 are controlled to alternately supply power to the electric bicycle 200.

Referring to FIG. 1, the management module 2 in the present embodiment is a battery management system and has both computational and storage capabilities. The management module 2 can obtain information of each of the two battery packs 1, so as to control one of the two battery packs 1 to supply power to the electric bicycle 200 and to control another one of the two battery packs 1 to suspend operation. Accordingly, one of the two battery packs that is suspended from operation can perform a cooling action, and then be used to replace another one of the two battery packs 1 that supplies power.

Specifically, the management module 2 can obtain a battery health data for each of the two battery packs 1. When the management module 2 detects that a first variation between two battery health data is greater than 2%, the management module 2 selects one of the two battery packs 1 in which the battery health data is high to supply power to the electric bicycle 200, and another one of the two battery packs 1 in which the battery health data is low is controlled to suspend operation. Conversely, when the management module 2 detects that the first variation between the two battery health data is less than 2%, the management module selects one of the two battery packs 1 to supply power to the electric bicycle according to a first rule (which will be described later).

For example, when the two pieces of the battery health data for the two battery packs 1 are respectively 90% and 85%, the management module 2 can actively control one of the two battery packs 1 in which the battery health data is 90% to supply power, and actively control another one of the two battery packs 1 in which the battery health data is 85% to suspend operation. Conversely, when the two pieces of the battery health data for the two battery packs 1 are respectively 90% and 89%, the management module 2 selects one of the two battery packs 1 to supply power to the electric bicycle 200 according to the first rule.

It should be noted that each of the two battery health data in the present embodiment is represented by a relationship of G×Δv/Δi, Δv represents a sampled voltage variation of each of the two battery packs 1 within a unit of time, Δi represents a sampled current variation of each of the two battery packs 1 within a unit of time, and G represents an ideal weighted value obtained through Taguchi methods.

In practical applications, personnel first select five experiment subjects with the same specifications and design a target parameter (i.e., a battery health factor and its level) to choose an appropriate orthogonal table. Furthermore, the personnel use a signal/noise ratio (S/N) analysis and an analysis of variance to test an influence degree of the target parameter on each of the experiment subjects, so as to obtain the ideal weighted value that allows the relationship of Δv/Δi to approach an actual battery degradation. Since using the Taguchi methods to obtain the ideal weighted value is well known to those skilled in the art, details thereof will not be specially described herein.

Then, the personnel can write the ideal weighted value into the management module 2, and the management module 2 can perform weighted calculation after obtaining the sampled voltage variation of each of the two battery packs 1 within the unit of time and the sampled current variation of each of two battery packs 1 within the unit of time, so as to obtain each of the two pieces of the battery health data. Accordingly, the management module 2 can obtain the battery health data of each of the two battery packs 1 at different time points, and compare the battery health data of the two battery packs 1.

Naturally, in certain embodiments of the present disclosure (not shown), the ideal weighted value can be omitted from the relationship of the battery health data. That is, the relationship of the battery health data is Δv/Δi.

Preferably, the management module 2 can also obtain a battery capacity data for each of the two battery packs 1, so as to determine the first rule. Specifically, in the first rule, when the management module 2 detects that a second variation between the two battery capacity data is greater than 50%, the management module 2 selects one of the two battery packs 1 in which the battery capacity data is high to supply power to the electric bicycle 200, and another one of the two battery packs 1 in which the battery health data is low is controlled to suspend operation. When the management module 2 detects that the second variation between the two battery capacity data is less than 50%, the management module 2 selects one of the two battery packs 1 to supply power to the electric bicycle 200 according to a second rule (which will be described later).

It should be noted that each of the two battery capacity data is represented by a relationship of Σₜ₌₀^{t=K} i_{c}×t, i_{c} represents a current value of each of the two battery packs 1, and K represents a predetermined time programmed for each of the two battery packs 1, but the present disclosure is not limited thereto.

In a practical application, the management module 2 can also obtain the sampled voltage variation within the unit of time from each of the two battery packs 1, so as to determine the second rule. In the second rule, the management module 2 selects one of the two battery packs 1 in which the sampled voltage variation is high to supply power to the electric bicycle 200, and another one of the two battery packs 1 in which the sampled voltage variation is low to suspend operation.

The sampled voltage variation is represented by a relationship of V_{C1}−V_{C2}, V_{C1} represents a current voltage value obtained as a steady-state average of the current using Ohm impedance as a reference value, and V_{C2} represents a current voltage value obtained using a current threshold value that exceeds a polarization impedance as a reference value.

For example, when a capacitance of each of the two battery packs 1 is 10 ampere-hours, the ohm impedance is a steady-state current of 10 amperes, and the current threshold value that exceeds the polarization impedance is 2 amperes, V_{C1} is the current voltage value obtained by the battery pack 1 at 1 C (C-rate), and V_{C2} is the current voltage value obtained by the battery pack 1 at 0.2 C (C-rate).

In another practical application, the management module 2 can also obtain a surface temperature from each of the two battery packs 1 to determine the second rule. In the second rule, the management module 2 selects one of the two battery packs 1 whose surface temperature is greater than a predetermined threshold value to suspend operation, and the management module 2 selects another one of the two battery packs 1 whose surface temperature is less than or equal to the predetermined threshold value to supply power to the electric bicycle 200. The predetermined threshold value is a predetermined maximum temperature value obtained by each of the two battery packs 1 using the Taguchi methods, and the predetermined maximum temperature value is a maximum temperature that may significantly affect the service life of the two battery packs 1.

It should be noted that FIG. 2 is a graph of the battery device 100 during actual operation of the present disclosure. The horizontal axis represents Ampere-hours, and the vertical axis represents temperature. The graph includes two temperature data lines T1, T2 and two capacitance data lines G1, G2 of the two battery packs 1. It can be seen from FIG. 2 that, when the capacitance of each of the two battery packs 1 is between 60 ampere hours and 85 ampere hours, the temperature of each of the two battery packs 1 is less than 68° C. In other words, the two battery packs 1 do not reach a peak temperature after being almost fully discharged. In addition, in the present embodiment, the battery device 100 includes the two battery packs 1. However, in certain embodiments of the present disclosure (not shown), the battery device 100 may include multiple ones of the battery pack 1.

### Second Embodiment

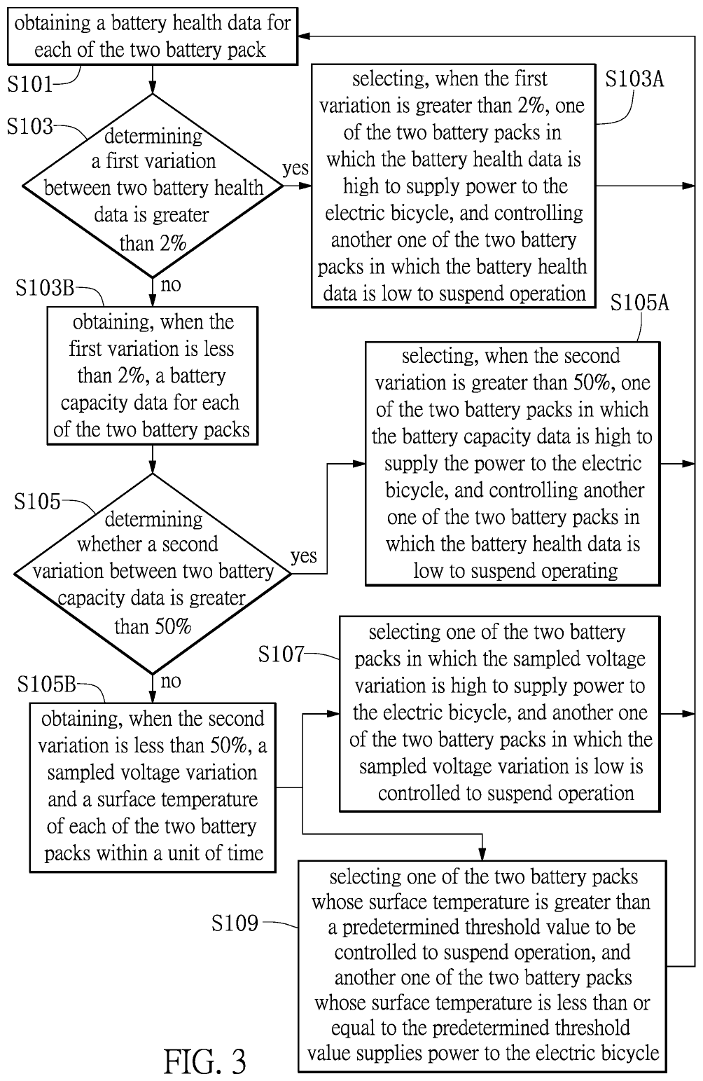

Referring to FIG. 3, a second embodiment of the present disclosure provides a battery management method. The battery management method can be applied to a battery device 100 (e.g., the battery device 100 in the first embodiment) of an electric bicycle, and the battery device 100 includes two battery packs 1. The battery management method includes steps S101-S109. Naturally, any of the aforementioned steps can be omitted or replaced with reasonable variations according to requirements of a designer.

Step S101: obtaining a battery health data for each of the two battery packs 1.

Step S103: determining a first variation between two battery health data is greater than 2%.

Step S103A: selecting, when the first variation is greater than 2%, one of the two battery packs 1 in which the battery health data is high to supply power to the electric bicycle 200, and controlling another one of the two battery packs 1 in which the battery health data is low to suspend operation. Then, the battery management method returns to step S101.

Step S103B: obtaining, when the first variation is less than 2%, a battery capacity data for each of the two battery packs 1.

Step S105: determining whether a second variation between two battery capacity data is greater than 50%.

Step S105A: selecting, when the second variation is greater than 50%, one of the two battery packs 1 in which the battery capacity data is high to supply the power to the electric bicycle 200, and controlling another one of the two battery packs 1 in which the battery health data is low to suspend operating. Then, the battery management method returns to step S101.

Step S105B: obtaining, when the second variation is less than 50%, a sampled voltage variation and a surface temperature of each of the two battery packs 1 within a unit of time. Then, the battery management method proceeds to step S107 or step S109. Naturally, step S105B may be optionally followed by step S107 and step S109 as appropriate.

Step S107: selecting one of the two battery packs 1 in which the sampled voltage variation is high to supply power to the electric bicycle 200, and another one of the two battery packs 1 in which the sampled voltage variation is low is controlled to suspend operation. Then, the battery management method returns to step S101.

Step S109: selecting one of the two battery packs 1 whose surface temperature is greater than a predetermined threshold value to be controlled to suspend operation, and another one of the two battery packs 1 whose surface temperature is less than or equal to the predetermined threshold value supplies power to the electric bicycle 200. Then, the battery management method returns to step S101.

Calculation methods for each piece of the battery health data, each piece of the battery capacity data, and the predetermined threshold value in the present embodiment are generally similar to those of the first embodiment, and details thereof will not be specially described herein.

### Beneficial Effects of the Embodiments

In conclusion, in the battery device and the battery management method provided by the present disclosure, by virtue of “in response to the management module detecting that a first variation between the two pieces of the battery health data being greater than 2%, the management module selects one of the two battery packs in which the battery health data is high to supply power to the electric bicycle, and another one of the two battery packs in which the battery health data is low is controlled to suspend operation,” the battery device can reduce the number of times that the two battery packs reach a peak temperature, thereby improving the overall service life of the battery device.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A battery device, which is configured to be installed on an electric bicycle, the battery device comprising:
two battery packs; and
a management module electrically coupled to the two battery packs, wherein the management module is configured to obtain a piece of battery health data for each of the two battery packs; wherein, when the management module detects that a first variation between the two pieces of the battery health data is greater than 2%, the management module selects one of the two battery packs in which the battery health data is high to supply power to the electric bicycle, and another one of the two battery packs in which the battery health data is low is controlled to suspend operation; wherein, when the management module detects that the first variation between the two pieces of the battery health data is less than 2%, the management module selects one of the two battery packs to supply the power to the electric bicycle according to a first rule.

2. The battery device according to claim 1, wherein each of the two pieces of the battery health data is represented by a relationship of G×Δv/Δi, Δv represents a sampled voltage variation of each of the two battery packs within a unit of time, Δi represents a sampled current variation of each of the two battery packs within the unit of time, and G represents an ideal weighted value obtained through Taguchi methods.

3. The battery device according to claim 1, wherein the management module is configured to obtain a piece of battery capacity data for each of the two battery packs; wherein, in the first rule, when the management module detects that a second variation between the two pieces of the battery capacity data is greater than 50%, the management module selects one of the two battery packs in which the battery capacity data is high to supply the power to the electric bicycle, and another one of the two battery packs in which the battery health data is low is controlled to suspend operation; wherein, in the first rule, when the management module detects that the second variation between the two pieces of the battery capacity data is less than 50%, the management module selects one of the two battery packs to supply the power to the electric bicycle according to a second rule.

4. The battery device according to claim 3, wherein each of the two pieces of the battery capacity data is represented by a relationship of Σₜ₌₀^{t=K} i_{c}×t, i_{c} represents a current value of each of the two battery packs, and K represents a predetermined time that is programmed for each of the two battery packs.

5. The battery device according to claim 3, wherein the management module is configured to obtain a sampled voltage variation from each of the two battery packs within a unit of time; wherein, in the second rule, the management module selects one of the two battery packs in which the sampled voltage variation is high to supply the power to the electric bicycle, and another one of the two battery packs in which the sampled voltage variation is low is controlled to suspend operation.

6. The battery device according to claim 5, wherein the sampled voltage variation is represented by a relationship of V_{C1}−V_{C2}, V_{C1} represents a current voltage value obtained by using an ohm impedance that is a steady-state current average as a reference value, and V_{C2} represents a current voltage value obtained by using a current threshold value that exceeds a polarization impedance as the reference value.

7. The battery device according to claim 3, wherein the management module is configured to obtain a surface temperature from each of the two battery packs; wherein, in the second rule, the management module controls one of the two battery packs in which the surface temperature is greater than a predetermined threshold value to suspend operation, and the management module selects another one of the two battery packs in which the surface temperature is less than or equal to the predetermined threshold value to supply the power to the electric bicycle.

8. The battery device according to claim 7, wherein the predetermined threshold value is a predetermined maximum temperature value obtained by each of the two battery packs using Taguchi methods.

9. A battery management method, wherein the battery management method is applicable to a battery device of an electric bicycle, and the battery device includes two battery packs, the battery management method comprising:
obtaining a piece of battery health data for each of the two battery packs;
determining whether or not a first variation between the two pieces of the battery health data is greater than 2%; wherein, when the first variation is greater than 2%, one of the two battery packs in which the battery health data is high supplies power to the electric bicycle, and another one of the two battery packs in which the battery health data is low is controlled to suspend operation; wherein, when the first variation is less than 2%, a piece of battery capacity data is obtained for each of the two battery packs;
determining whether or not a second variation between the two pieces of the battery capacity data is greater than 50%; wherein, when the second variation is greater than 50%, one of the two battery packs in which the battery capacity data is high supplies the power to the electric bicycle, and another one of the two battery packs in which the battery health data is low is controlled to suspend operation; wherein, when the second variation is less than 50%, a sampled voltage variation and a surface temperature of each of the two battery packs within a unit of time are obtained;
selecting one of the two battery packs in which the sampled voltage variation is high to supply the power to the electric bicycle, and controlling another one of the two battery packs in which the sampled voltage variation is low to suspend operation; and
controlling one of the two battery packs in which the surface temperature is greater than a predetermined threshold value to suspend operation, and selecting another one of the two battery packs in which the surface temperature is less than or equal to the predetermined threshold value to supply the power to the electric bicycle.

10. The battery management method according to claim 9, wherein each of the two pieces of the battery health data is represented by a relationship of G×Δv/Δi, Δv represents the sampled voltage variation of each of the two battery packs within the unit of time, Δi represents a sampled current variation of each of the two battery packs within a unit of time, and G represents an ideal weighted value obtained through Taguchi methods; wherein each of the two pieces of the battery capacity data is represented by a relationship of Σₜ₌₀^{t=K} i_{c}×t, i_{c} represents a current value of each of the two battery packs, and K represents a predetermined time programmed for each of the two battery packs; wherein the sampled voltage variation is represented by a relationship of V_{C1}−V_{C2}, V_{C1} represents a current voltage value obtained as a steady-state average of the current using Ohm impedance as a reference value, and V_{C2} represents a current voltage value obtained using a current threshold value that exceeds a polarization impedance as a reference value.
